(19) United States
(12) Patent Application Publication
(10) Pub. No.: US 2008/0312352 A1
(43) Pub. Date: Dec. 18, 2008

(54) Dyes and Dye Mixtures for Dying Polymers, Method for the Production Thereof and Their Use

(75) Inventors: Gunter Georlitz, Bad Soden (DE); Markus Arnold, Kelsterbach (DE)

Correspondence Address: CONNOLLY BOVE LODGE & HUTZ, LLP, P O BOX 2207, WILMINGTON, DE, 19899, US

(73) Assignee: DyStar Textilfarben GmbH & Co. Deutschland KG, Frankfurt am Main (DE)

(21) Appl. No.: 12/088,537

(22) PCT Filed: Sep. 26, 2006
(86) PCT No.: PCT/EP2006/066766

§ 371 Date: Sep. 2, 2008

(30) Foreign Application Priority Data
Oct. 1, 2005 (DE) 10 2005 047 290.7

(51) Int. Cl. C08K 5/23; C09B 29/42; C08L 75/04

(52) U.S. Cl. 521/155; 534/773; 8/662; 524/715

(57) ABSTRACT

The present invention relates to dyes of the general formula (1)

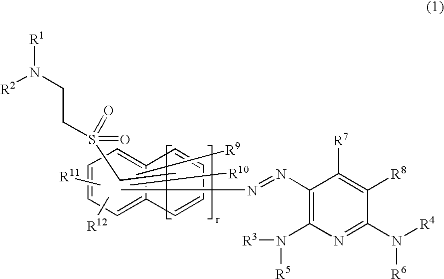

where R¹ to R¹² and r are each as defined in claim 1, dye mixtures comprising more than one dye of the general formula (1), their preparation and their use for coloring polymers, particularly polyurethane and polyurethane foam.

Polymers can be colored with dyes in various ways. One way is mass coloration of polymers whereby for example a pigment or a dye is mixed with the polymer and the polymer is melted to transport the dye into the polymer matrix. Other processes involve the polymer being colored or, to be more precise, dyed by the dyes diffusing into the polymer from a solution or dispersion, examples being the dyeing of polymeric fibers composed of polyester, polyacrylonitrile, polyurethane, cellulose or polyamide for example with, for example, disperse dyes, cationic dyes, acid dyes, metallized dyes or reactive dyes, the use of reactive dyes resulting in a covalent bond being formed between the dye and the substrate, conferring particularly high fastnesses on the dyeings. Another way to color a polymer is to add a dye to the polymer's monomers or oligomers before the polymer is produced or as it is being produced. Dyes capable of forming covalent bonds with the polymer scaffold will here likewise result in colorations of high fastness. For this, the dyes used, or to be more precise, their chromophores have to be sufficiently stable under the conditions of the polymerization. These requirements vary with the type of polymerization. Polyurethanes are produced by essentially polymerizing the isocyanates with diols or polyols. Polyurethane foam is generated by adding water to the reaction mixture or using a blowing gas. Furthermore, stabilizers and activators such as for example amines, silicones and tin compounds are added to the reactants prior to the polymerization. The polymerization proceeds at elevated temperatures in the presence of highly reactive compounds and intermediates. To produce colored polyurethanes, the diol or polyol component may have added to it, before the polymerization, dyes which contain at least two hydroxyl groups, so that the dye can be covalently incorporated in the polymer chains during the polymerization without chain termination taking place as a result. The dye used must not affect the mechanical properties of the polyurethane. When the dye used is a solid material, it is advantageously dissolved in a solvent beforehand or used as a dye dispersion in a polyol for example.

Dyes of this kind are known and are described in DE2259435, DE2357933. However, the known dyes do not fulfill all the expectations with regard to dye stability under the particular polymerization conditions. Where polyurethane foams are produced, some dyes affect foam structure and hence foam mechanical properties, so that the colored foam has different mechanical properties than the uncolored foam, and that is undesirable. The actually available suitable disperse dyes for producing colored polyurethane foam do not make it possible to cover every desired region in color space. There is therefore a need for dyes which have the specified properties and thus are useful for the coloration of polyurethane.

It has now been found that dyes of the general formula (1) overcome the abovementioned disadvantages in polyurethane coloration in that they possess high stability under application conditions and afford colorations having high fastnesses.

The present invention accordingly provides the dyes of the general formula (1)

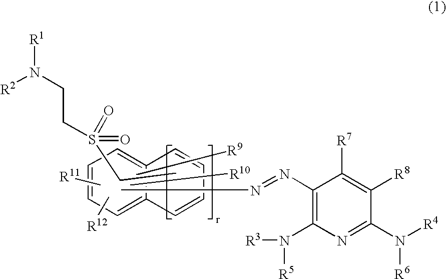

where
R¹ is aryl which is substituted by at least one hydroxyl group and may additionally also be substituted by alkoxy, hydroxy-(C₁-C₄₀)-alkyl, (C₁-C₄₀)-alkyl, aryl, (C₂-C₄₀)-alkylene, halogen, carboxylic ester, carboxamido or cyano; (C₁-C₆₀)-alkyl which is substituted by at least one hydroxyl group and may additionally also be substituted by alkoxy, hydroxy-(C₁-C₄₀)-alkyl-, (C₁-C₄₀)-alkyl, aryl, (C₂-C₄₀)-alkylene, halogen, carboxylic ester, carboxamido or cyano or interrupted by oxygen, alkoxylene, arylene, carbonyl, carboxylic ester, carboxamido, sulfone or NR¹³, where R¹³ is hydrogen, aryl, alkoxy, hydroxyalkyl, alkyl or is alkyl interrupted by oxygen, alkoxylene, arylene, carbonyl, carboxylic ester, carboxamido or sulfone;
R² is hydrogen; aryl; aryl substituted by hydroxyl, alkoxy, hydroxy-(C₁-C₄₀)-alkyl, (C₁-C₄₀)-alkyl, aryl, (C₂-C₄₀)-alkylene, halogen, carboxylic ester, carboxamido or cyano; (C₁-C₆₀)-alkyl; (C₁-C₆₀)-alkyl substituted by hydroxyl, alkoxy, hydroxy-(C₁-C₄₀)-alkyl, (C₁-C₄₀)-alkyl, aryl, (C₂-C₄₀)-alkylene, halogen, carboxylic ester, carboxamido or cyano; or (C₁-C₆₀)-alkyl interrupted by oxygen, alkoxylene, arylene, carbonyl, carboxylic ester, carboxamido, sulfone or NR¹⁴, where R¹⁴ is hydrogen, aryl, alkoxy, hydroxyalkyl, alkyl or is alkyl interrupted by oxygen, alkoxylene, arylene, carbonyl, carboxylic ester, carboxamido or sulfone;
R³ and R⁴ are independently hydrogen; aryl; aryl substituted by hydroxyl, alkoxy, hydroxy-(C₁-C₄₀)-alkyl, (C₁-C₄₀)-alkyl, aryl, (C₂-C₄₀)-alkylene, halogen, carboxylic ester, carboxamido or cyano; (C₁-C₆₀)-alkyl; (C₁-C₆₀)-alkyl substituted by hydroxyl, alkoxy, hydroxy-(C₁-C₄₀)-alkyl, (C₁-C₄₀)-alkyl, aryl, (C₂-C₄₀)-alkylene, halogen, carboxylic ester, carboxamido or cyano; or (C₁-C₆₀)-alkyl interrupted by oxygen, alkoxylene, arylene, carbonyl, carboxylic ester, carboxamido, sulfone or NR¹⁵, where R¹⁵ is hydrogen, aryl, alkoxy, hydroxyalkyl, alkyl or is alkyl interrupted by oxygen, alkoxylene, arylene, carbonyl, carboxylic ester, carboxamido or sulfone;
R⁵ and R⁶ are independently hydrogen; aryl; aryl substituted by hydroxyl, alkoxy, hydroxy-(C₁-C₄₀)-alkyl, (C₁-C₄₀)-alkyl, aryl, (C₂-C₄₀)-alkylene, halogen, carboxylic ester, carboxamido or cyano; (C₁-C₆₀)-alkyl; (C₁-C₆₀)-alkyl aryl, (C₂-C₄₀)-alkylene, halogen, carboxylic ester, carboxamido or cyano; or (C₁-C₆₀)-alkyl interrupted by oxygen, alkoxylene, arylene, carbonyl, carboxylic ester, carboxamido, sulfone or NR¹⁶, where R¹⁶ is hydrogen, aryl, alkoxy, hydroxyalkyl, alkyl or is alkyl interrupted by oxygen, alkoxylene, arylene, carbonyl, carboxylic ester, carboxamido or sulfone;
R⁷ is hydrogen or (C₁-C₄)-alkyl;
R⁸ is cyano, carbamoyl or sulfomethyl;
R⁹ to R¹² are independently hydrogen; aryl; aryl substituted by hydroxyl, alkoxy, hydroxy-(C₁-C₄₀)-alkyl, (C₁-C₄₀)-alkyl, aryl, (C₂-C₄₀)-alkylene, halogen, carboxylic ester, carboxamido or cyano; hydroxyl, alkoxy, (C₂-C₄₀)-alkylene, halogen, carboxylic ester, carboxamido, cyano, (C₁-C₆₀)-alkyl; (C₁-C₆₀)-alkyl substituted by hydroxyl, alkoxy, hydroxy-(C₁-C₄₀)-alkyl, (C₁-C₄₀)-alkyl, aryl, (C₂-C₄₀)-alkylene, halogen, carboxylic ester, carboxamido or cyano; or (C₁-C₆₀)-alkyl interrupted by oxygen, alkoxylene, arylene, carbonyl, carboxylic ester, carboxamido, sulfone or NR¹⁷, where R¹⁷ is hydrogen, aryl, alkoxy, hydroxyalkyl, alkyl or is alkyl interrupted by oxygen, alkoxylene, arylene, carbonyl, carboxylic ester, carboxamido or sulfone; or
two of the R⁹ to R¹² radicals combine with the carbon atoms to which they are attached to form a ring which may be substituted by hydroxyl, alkoxy, hydroxy-(C₁-C₄₀)-alkyl, (C₁-C₄₀)-alkyl, aryl, (C₂-C₄₀)-alkylene, halogen, carboxylic ester, carboxamido or cyano; and
r is 0 or 1;
one or more of the R² to R¹⁷ radicals each containing at least one hydroxyl group.

In preferred dyes of the general formula (1), preferably

R¹ is hydroxy-(C₁-C₄)-alkyl or hydroxy-(C₁-C₄)-alkoxy-(C₁-C₄)-alkyl;
R² is hydrogen, (C₁-C₄)-alkyl, hydroxy-(C₁-C₄)-alkyl or
hydroxy-(C₁-C₄)-alkoxy-(C₁-C₄)-alkyl;
R³ and R⁴ are each hydrogen;
R⁵ and R⁶ are independently hydrogen; (C₁-C₄)-alkyl; hydroxy-(C₁-C₄)-alkyl; hydroxy-(C₁-C₄)-alkoxy-(C₁-C₄)-alkyl; (C₁-C₄)-alkoxy-(C₁-C₄)-alkyl; phenyl; or
R⁷ is (C₁-C₄)-alkyl;
R⁸ is cyano; and
R⁹ and R¹² are independently hydrogen, (C₁-C₄)-alkyl or (C₁-C₄)-alkoxy; and
r is 0 or 1.

(C₁-C₄)-Alkyl groups, which may be straight chain or branched, are for example methyl, ethyl, n-propyl, isopropyl, n-butyl or isobutyl. The same is true of (C₁-C₄)-alkoxy groups, mutatis mutandis.

Preference is further given to those dyes of the general formula (1) where R³ or R⁴ is hydrogen or at least one of the substituents R⁵ and R⁶ independently bears a hydroxyl group.

Present invention dyes of the general formula (1) where r is 0 have the general formula (1a)

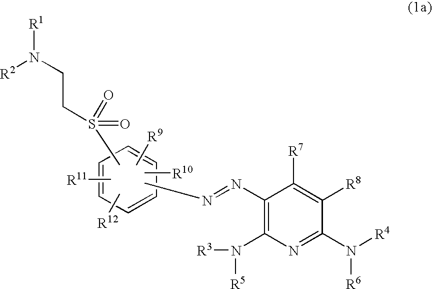

where R¹ to R¹² are each as defined above. Compounds of the general formula (1a) are preferred and particularly preferred when R¹ to R¹² have the meanings identified above as preferred.

Present invention dyes of the general formula (1) where r is 1 have the general formula (1b)

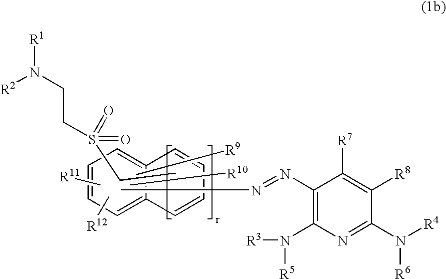

where R¹ to R¹² are each as defined above.

Particularly preferred dyes of the present invention conform to the general formula (1c)

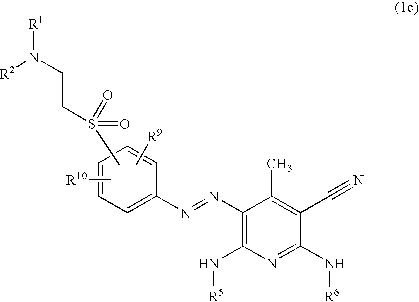

where
R¹ is hydroxyethyl, hydroxypropyl or hydroxyethoxyethyl,
R² is methyl, ethyl, hydroxyethyl, hydroxypropyl or hydroxyethoxyethyl,
R⁵ and R⁶ are independently hydrogen, (C₁-C₄)-alkyl, hydroxyethyl, hydroxypropyl, hydroxy-(C₁-C₄)-alkoxyethyl, ethoxy-(C₁-C₄)-alkyl, methoxy-(C₁-C₄)-alkyl, phenyl, methylphenyl or methoxyphenyl; and
R⁹ and R¹⁰ are independently hydrogen, methyl or methoxy.

The present invention's compounds of the general formula (1) are obtainable for example by a compound of the general formula (D1)

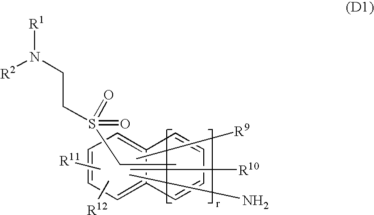

where R¹, R², R⁹ to R¹² and r are each as defined above, being diazotized and coupled onto a compound of the general formula (K1)

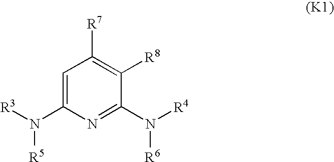

where R³ to R⁸ are each as defined above.

Diazotization and coupling are generally effected in accordance with methods known to one skilled in the art. For instance, diazotization is effected with sodium nitrite in an acidic medium, while coupling is effected for example at −5 to 80° C. and preferably at 0 to 40° C. and pH values of <0 to 10 and preferably at pH values in the range from 0 to 5.

The compounds of the general formula (D1) are obtainable by reacting a 2-(aminoarylsulfonyl)ethyl sulfuric acid monoester of the general formula (A1)

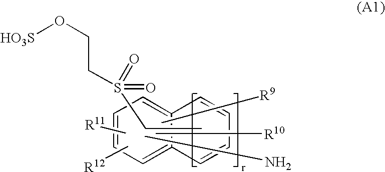

or an alkali metal salt thereof where r and R⁹ to R¹² are each as defined above, with an amine of the general formula HNR¹R², where R¹ and R² are each as defined above.

This reaction is preferably effected in water at preferably 25 to 95° C. and particularly at 35 to 60° C., and at a pH of preferably 9 to 11.5 and particularly of 10 to 11.

The compounds of the general formula (K1) are obtainable in a known manner from dichloropyridines of the general formula (C1)

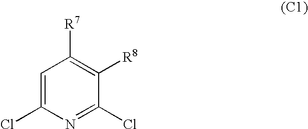

where R⁷ and R⁸ are each as defined above, and amines of the formulae HNR³R⁵ and HNR⁴R⁶, where R³ to R⁶ are each as defined above.

If appropriate, further substitutions can be carried out on the R³ to R⁸ radicals, examples being saponifications, esterifications, etherifications, amide formation, alkylations and halogenations, as described in DE 3025904 for example.

In a further process for preparing the present invention's compounds of the general formula (1), a compound of the general formula (ZP1)

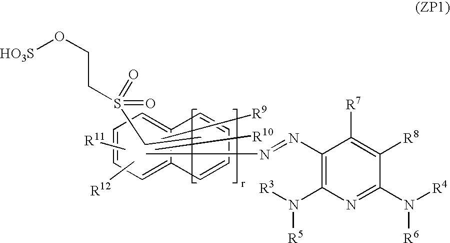

where R³ to R¹² and also r are each as defined above, is reacted with an amine of the formula HNR¹R², where R¹ and R² are each as defined above.

The compounds of the general formula (ZP1) are obtainable by diazotization of a compound of the general formula (A1) and coupling onto a compound of the general formula (K1) by conventional methods.

The sulfuric acid ester group HO₃SOCH₂CH₂SO₂— can if desired be converted into the vinyl form H₂C═CHSO₂—, by the addition of alkali, not only in the compound of the general formula (A1) but also in the compound of the general formula (ZP1) before their reaction with the amine of the general formula HNR¹R².

Examples of compounds of the general formula (D1) are recited hereinbelow:

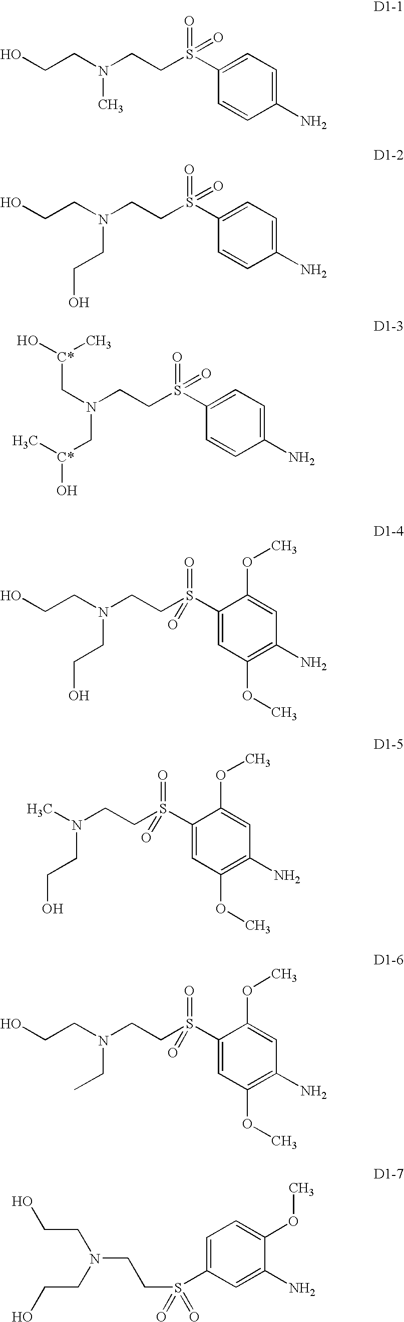

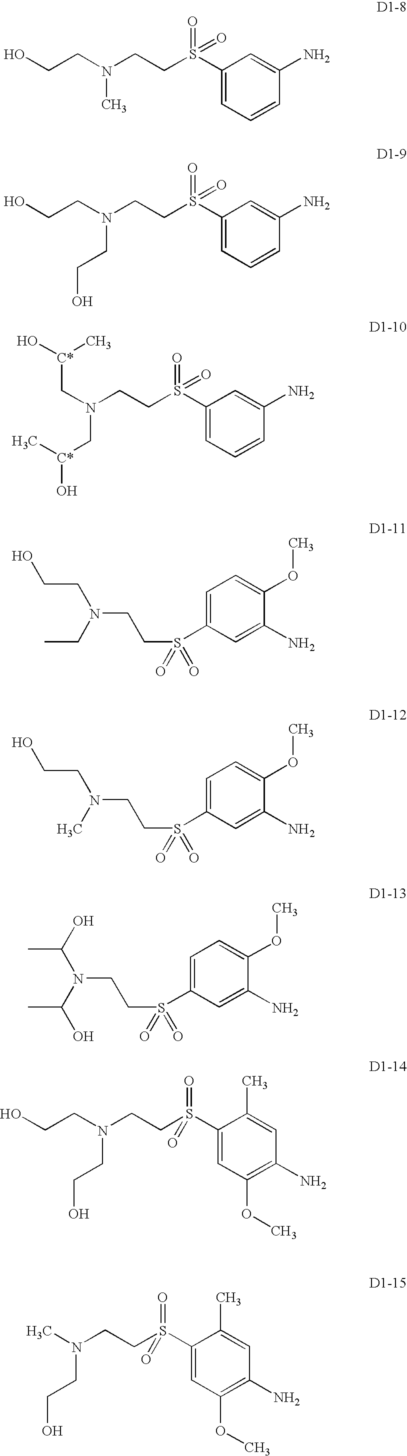

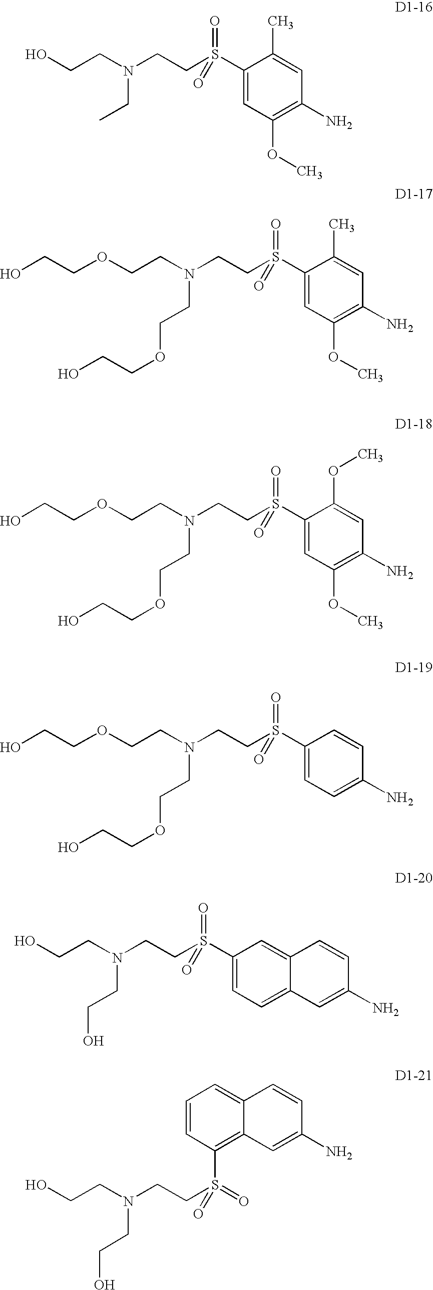

Examples of compounds of the general formula (K1) are recited hereinbelow:

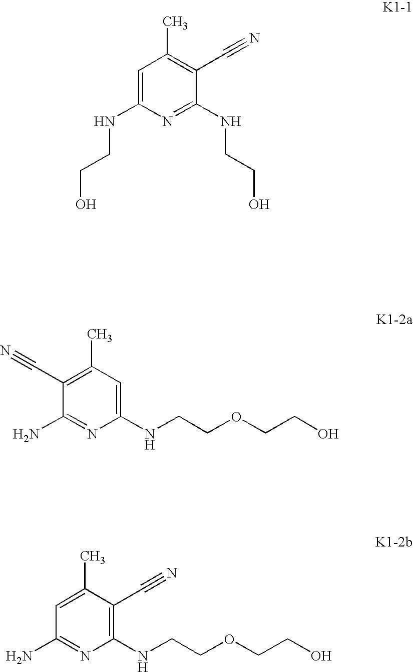

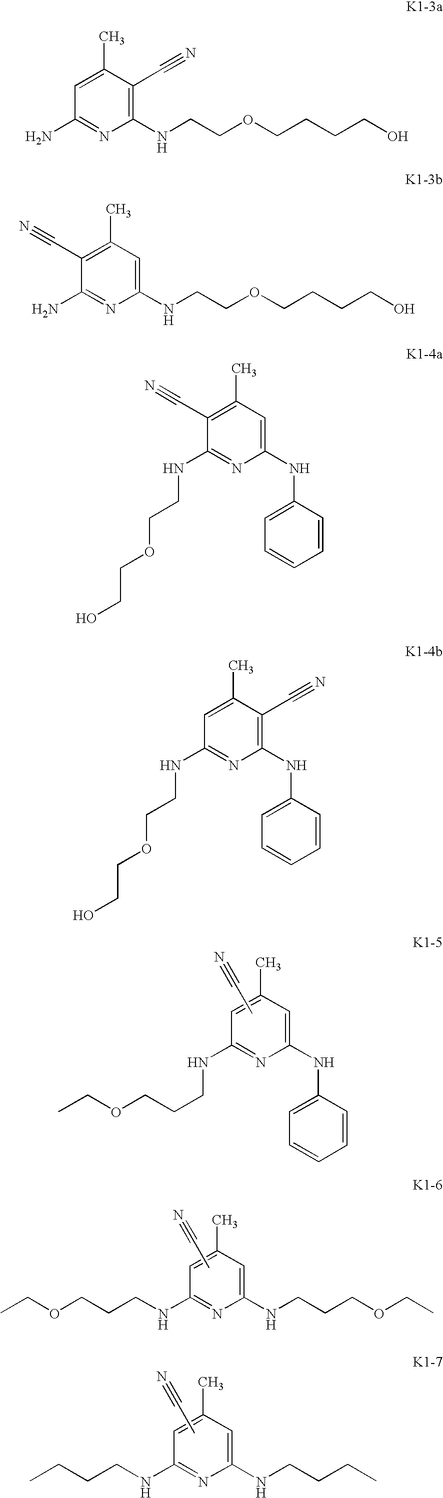

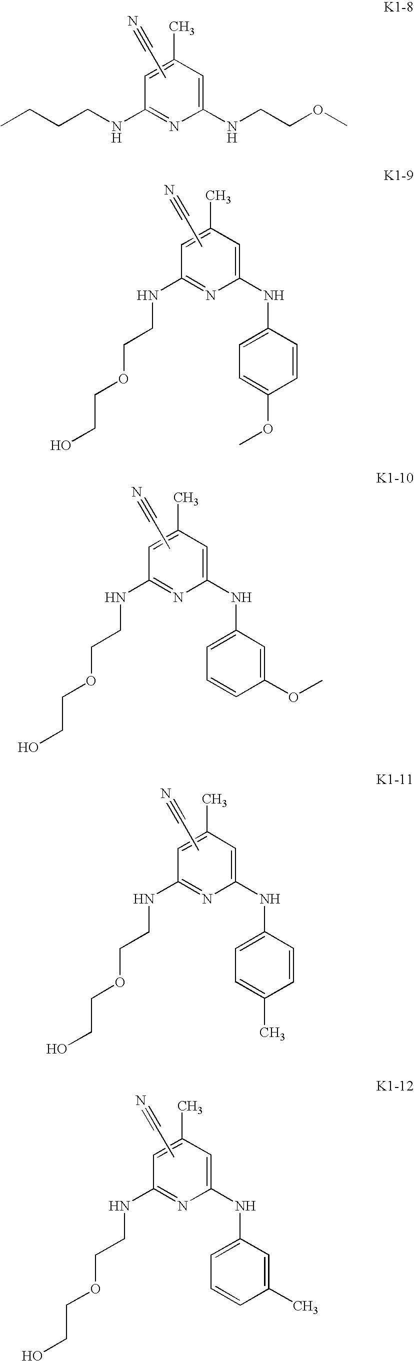

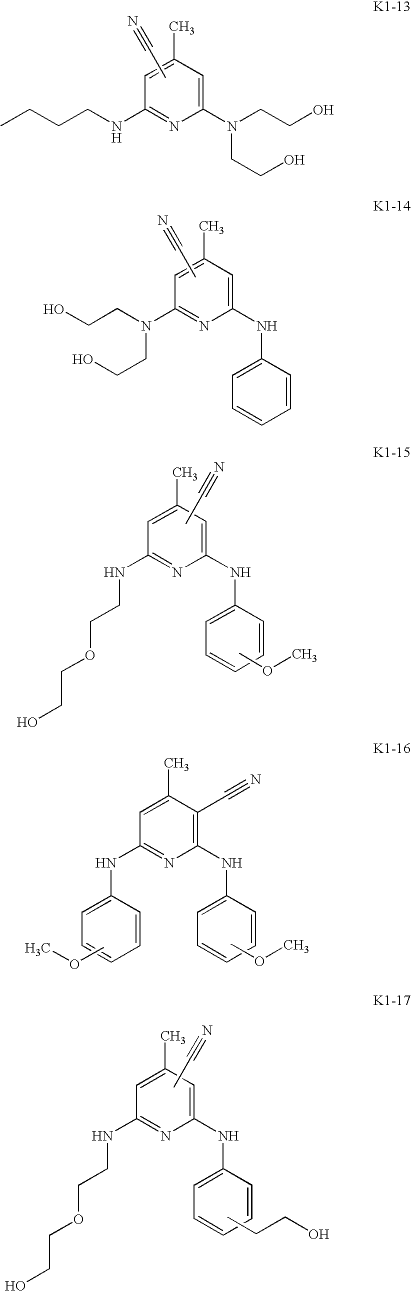

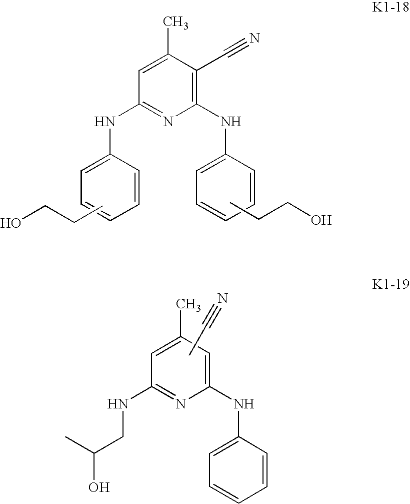

As synthesized, the compounds of the general formula (K1) are generally present in the form of mixtures, for example the compound of the formula K1-2a in admixture with the compound of the formula K1-2b. When such mixtures are used in the process of the present invention, corresponding mixtures of compounds of the general formula (1) are formed. Furthermore, the present invention's dyes of the general formula (1), or mixtures thereof, may, as synthesized, contain by-products, such as hydrolyzates for example. Such hydrolyzates can form for example when the sulfuric acid monoester grouping in the compound of the general formula (A1) hydrolyzes or the vinyl compound obtainable from the compound of the general formula (A1) adds water or when the dyes of the general formula (1) exchange the amine of the general formula HNR¹R² for water. Hydrolyzates further include products as can be formed by the hydrolysis or saponification of further functional groups, such as nitrile, acid amide or ester groups for example.

The present invention accordingly also provides dye mixtures comprising more than one dye of the general formula (1).

The present invention's dyes and dye mixtures can be generated as solids or liquids, i.e., solutions.

They can accordingly be isolated by suction filtration and drying, spray drying, evaporating or extracting and evaporating.

The present invention's dyes and dye mixtures can be used directly for polymer coloration, or they are subjected to a finishing operation. Finishing can be effected proceeding from a single dye or a mixture of a plurality of dyes and also mixtures with other dye classes such as for example pigments or solvent dyes, if appropriate with the assistance of auxiliaries, for example surface modifiers, dispersants by dispersing, suspending or dissolving in a liquid or solid carrier material and also if appropriate standardizing to a desired color strength and a desired hue and if appropriate drying the preparation thus obtained. Dustproofing agents can be additionally added in the latter case. If the dye is to be dispersed or suspended, the dye particles can be comminuted by grinding in a bead mill for example.

The present invention further provides for the use of the present invention's dyes and dye mixtures for coloring a polymer. A possible procedure is for the present invention's dyes and dye mixtures to be metered into the reaction mixture during the polymerization or to be admixed to one of the starting materials before the polymerization.

The present invention's dyes and dye mixtures are preferably used for coloring polyurethane by the compounds of the present invention either being added during the polymerization of diol/polyol and isocyanate or to be added before the polymerization to one of the starting materials. For example, the present invention's dye of the general formula (1) can be admixed to a polyetherpolyol or to a polyesterpolyol, and this preparation can then be used for the polymerization with a diisocyanate.

It is customary to use the abovementioned stabilizers, activators or catalysts in the polymerization.

The present invention's dyes and dye mixtures are particularly preferably used for coloring polyurethane foam. Polyurethane foam is produced according to the principle described above for polyurethane, the foam being produced by the addition of blowing gas or by the addition of water to the diol/polyol component, leading to the formation of carbon dioxide blowing gas.

Using the present invention's dyes and dye mixtures it is thus possible to produce colored polyurethane foams having no defects in the foam structure and good fastnesses and which are likewise part of the subject matter of the present invention.

The examples hereinbelow serve to elucidate the invention without restricting the invention to these examples. Parts and percentages are by weight, unless otherwise stated. Parts by weight relate to parts by volume as the kilogram to the liter,

### EXAMPLE 1

To a solution prepared from 281 parts of para base ester and 1000 parts of water and adjusted to pH 5 with 55 parts of sodium carbonate are added 75 parts of 2-methylaminoethanol, before heating to 40° C., adjusting to pH 10-11 with aqueous sodium hydroxide solution, stirring at 40° C. and maintaining the pH with aqueous sodium hydroxide solution until reaction to form the target product is complete. Complete reaction to form the target product is determined by chromatography. The reaction time is about 4 h. This is followed by acidifying with 250 parts of 31% hydrochloric acid, so that the pH drops to less than 1, to obtain 2342 parts of a solution containing the amine (D1-1) or its protonated form.

The (D1-1) contained in 234.2 parts of the solution thus obtained is diazotized with sodium nitrite solution in a conventional manner at 0-5° C. and half the reaction mixture obtained is admixed with 11.6 parts of the coupler (K1-1). Within 30 minutes, the pH is adjusted to 2.5 with 57 parts of 15% sodium carbonate solution, and the reaction mixture is stirred at pH 2.5 until reaction of the reactants is complete, during which the temperature of the reaction mixture rises to room temperature. The product thus obtained is filtered off with suction, the presscake obtained is suspended in water, the suspension is adjusted to pH 7-8 and filtered with suction, the presscake is washed saltfree with water dried at 50° C. under reduced pressure and ground to obtain 24.3 parts of the yellow dye in formula (1-1).

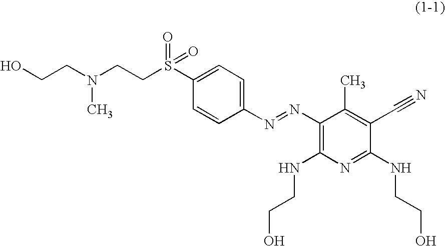

### EXAMPLE 2

Example 1 is repeated with 281 parts of para base ester and 105 parts of 2-(2-hydroxyethylamino)ethanol to obtain the amine (D1-2), dissolved under acidic conditions in 2515 parts of solution.

The amine (D1-2) contained in 251.1 parts of the solution thus obtained is diazotized with sodium nitrite solution in a conventional manner at 0-5° C. and half the reaction mixture obtained is admixed with 11.6 parts of the coupler (K1-1). Within 30 minutes, the pH is adjusted to 2.5 with 15% sodium carbonate solution, and the reaction mixture is stirred at pH 2.5 until reaction of the reactants is complete, during which the temperature of the reaction mixture rises to room temperature. The suspension is adjusted to pH 7-8 and filtered with suction, the presscake is washed saltfree with water dried at 50° C. under reduced pressure and ground to obtain 25.6 parts of the yellow dye in formula (12).

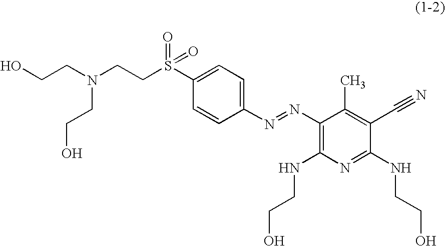

### EXAMPLE 3

Example 1 is repeated with 56 parts of para base ester and 27 parts of 1-(2-hydroxypropylamino)propan-2-ol to obtain the amine (D1-3) as an acidic solution, which is diazotized with sodium nitrite solution in a conventional manner at 0-5° C. and one quarter of the reaction mixture obtained is admixed with 11.8 parts of the coupler K1-1 (2,6-bis(2-hydroxyethylamino)-4-methylnicotinonitrile). Within 90 minutes, the pH is adjusted to 2.5 with 15% sodium carbonate solution and the reaction mixture is stirred at pH 2.5 until reaction of the reactants is complete, during which the temperature of the reaction mixture rises to room temperature. The suspension thus obtained is adjusted to pH 7-8 and filtered with suction, the presscake is washed saltfree with water, dried at 50° C. under reduced pressure and ground to obtain 27 parts of the yellow dye of the formula (1-3) as a mixture of the stereoisomers.

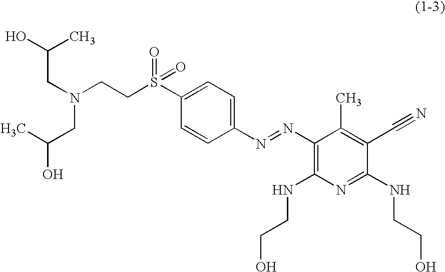

### EXAMPLE 4

The amines (D1-4), (D1-5) and (D1-6) are prepared, and dissolved under acidic conditions, similarly to the amines D1-1 to D1-3. A mixture of 116 parts of the amine D1-4, 159 parts of D1-5 and 166 parts of D1-6 is dissolved under acidic conditions as described above and diazotized at 0-5° C. in a conventional manner. To the resulting solution of the diazonium salts is added a mixture of 78.8 parts of the coupler K1-2 (consisting of the isomeric mixture of 2-amino-6-[2-(2-hydroxyethoxy)ethylamino]-4-methylnicotinonitrile and 6-amino-2-[2-(2-hydroxyethoxy)ethylamino]-4-methylnicotinonitrile) and 176 parts of the coupler K1-3 (consisting of the isomeric mixture of 2-amino-6-[2-(4-hydroxybutoxy)ethylamino]-4-methylnicotinonitrile and 6-amino-2-[2-(4-hydroxybutoxy)ethylamino]-4-methyl-nicotinonitrile).

The reaction mixture is stirred for 8 h, heated to 40° C., stirred for a further 3 hr cooled down to room temperature, adjusted to a pH 8.5 with aqueous sodium hydroxide solution and extracted with chloroform. The chloroform phase is washed with water, dried with sodium sulfate, filtered and the chloroform is evaporated under reduced pressure to leave an oily residue containing the dye mixture 1-4.

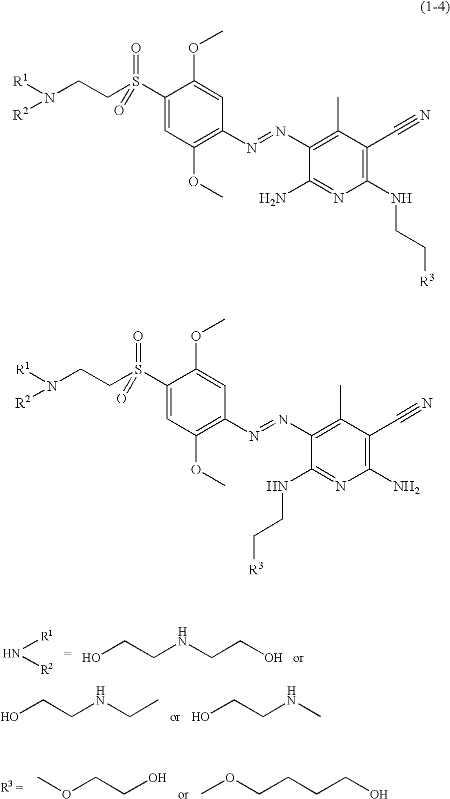

### EXAMPLE 5

The amine (D1-4) is prepared and diazotized in a conventional manner. The diazonium salt solution obtained from 35 parts of the amine (D1-4) is admixed with 31 parts of the coupler mixture (K1-4) previously dissolved in hydrochloric acid. The reaction mixture is stirred until reaction of the reactants is complete, the temperature being allowed to rise to room temperature. The pH of the reaction mixture is adjusted to 8.5 with aqueous sodium hydroxide solution, and the dye is filtered off with suction, washed saltfree with water, dried under reduced pressure at 50° C. and ground. The dye mixture obtained conforms to the formulae (I-5).

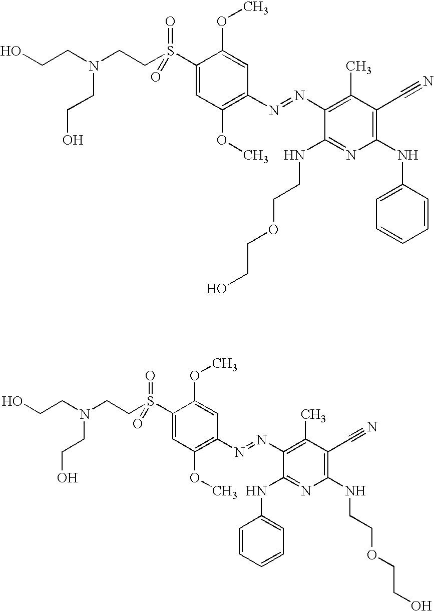

### EXAMPLE 6

The dye mixture (1-6) is obtained from the amine (D1-6) and the coupler (K1-4) similarly to Examples 1-5.

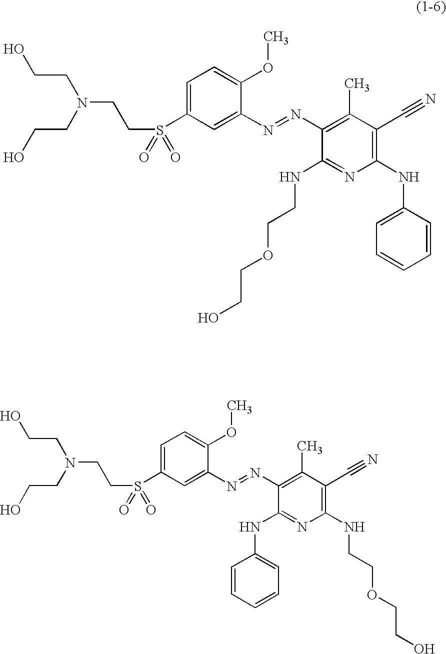

### EXAMPLE 7

The dye mixture 1-7 is obtained similarly to Example 4 and Example 5, respectively, using the solution of diazonium salts which is described in Example 3 and reaction of the diazonium salts with the coupler (K1-4).

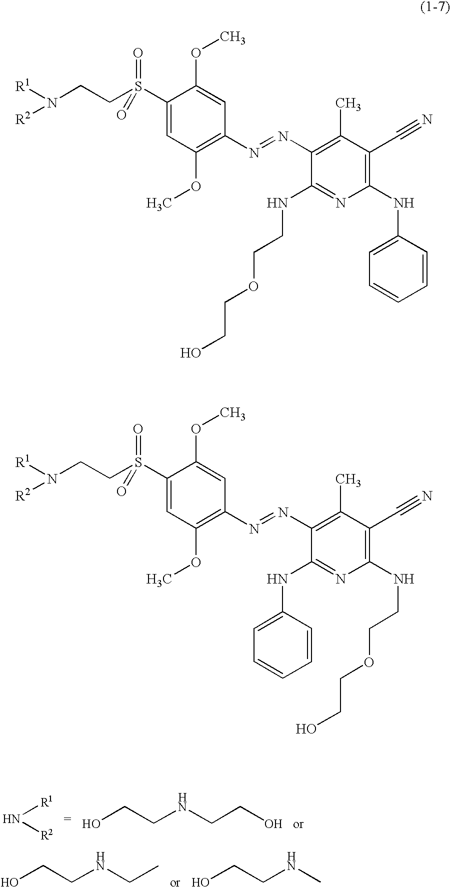

### EXAMPLE 8

20 parts of the dye mixture (1-5) of Example 5 are suspended in 80 parts of Ultramoll® and subsequently ground in a bead mill (Sussmeyer SME-Mk II with 273 parts of 0.4-0.7 mm ZrO2 beads). The dye dispersion obtained is heated to 60° C. and centrifuged to remove the beads.

100 parts of the Elastopan S 7521/102 polyol component from Elastogran GmbH are presented as an initial charge. One part of the dye paste described above is added to the initial charge. It is all stirred together intensively using a dissolver disk for 20-30 seconds. Then, 60 parts of IsoMMDI 92220 diisocyanate from Elastogran GmbH are speedily added before intensive stirring together for 7 seconds by means of the dissolver disk. The contents are then poured into a vessel to form the foam, for which vessels made of paper or cardboard are suitable. After about 5 minutes, the components will have reacted off and after a further 10 minutes the foam will have cured. It is allowed to cool down to room temperature, 20 minutes after cooling down, the foam can be sawn open to assess its hue. The foam obtained has a bright reddish orange color and has good fastnesses to perchloroethylene.

### EXAMPLE 9

0.17 part of the dye mixture corresponding to the formulae (1-5) of Example 5 are dissolved in one part of N-methylpyrrolidone (NMP).

100 parts of Elastopan S 7521/102 polyol component from Elastogran GmbH are presented as an initial charge. One part of the dye-NMP solution described above is added to the initial charge. It is all stirred together intensively using a dissolver disk for 20-30 seconds. Then, 60 parts of IsoMMDI 92220 diisocyanate from Elastogran GmbH are speedily added before intensive stirring together for 7 seconds by means of the dissolver disk. The contents are then poured into a vessel to form the foam, for which vessels made of paper or cardboard are suitable. After about 5 minutes, the components will have reacted off and after a further 10 minutes the foam will have cured. It is allowed to cool down to room temperature. 20 minutes after cooling down, the foam can be sawn open to assess its hue. The foam obtained has a bright reddish orange color and has good fastnesses to perchloroethylene.

### EXAMPLE 10

Example 8 is repeated using 0.2 of the dye mixture (1-6) of Example 6 to obtain a golden yellow foam having good fastnesses to perchloroethylene.

### EXAMPLE 11

70 parts of the dye mixture (1-4) of Example 4 are dissolved in 70 parts of Ultramoll®. Addition of 0.3 part of this Ultramoll dye solution to the polyol component in a procedure as described above gives a golden yellow polyurethane foam having good fastnesses to perchloroethylene.

The dyes or dye mixtures of Examples 12 to 31 hereinbelow are obtainable similarly to the methods described in the preceding examples.

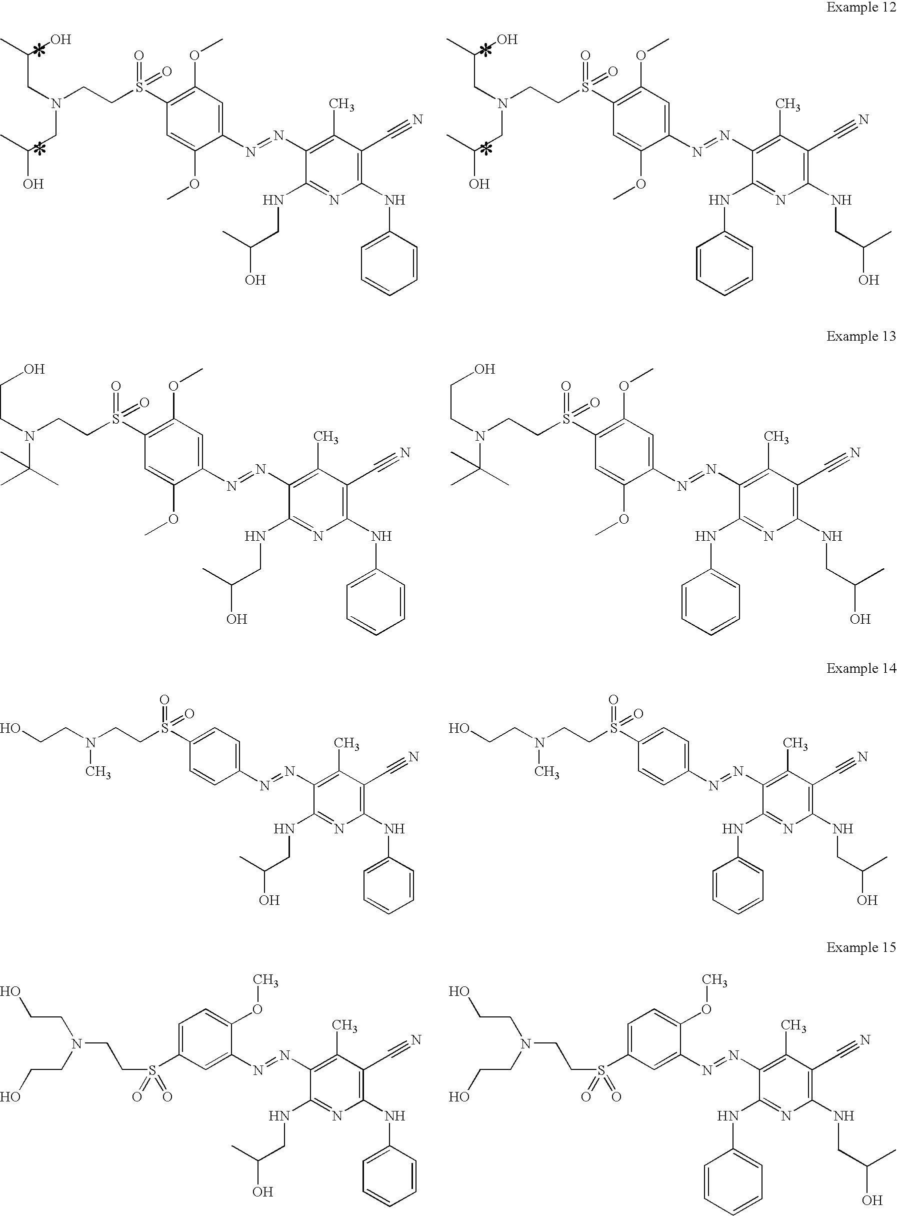

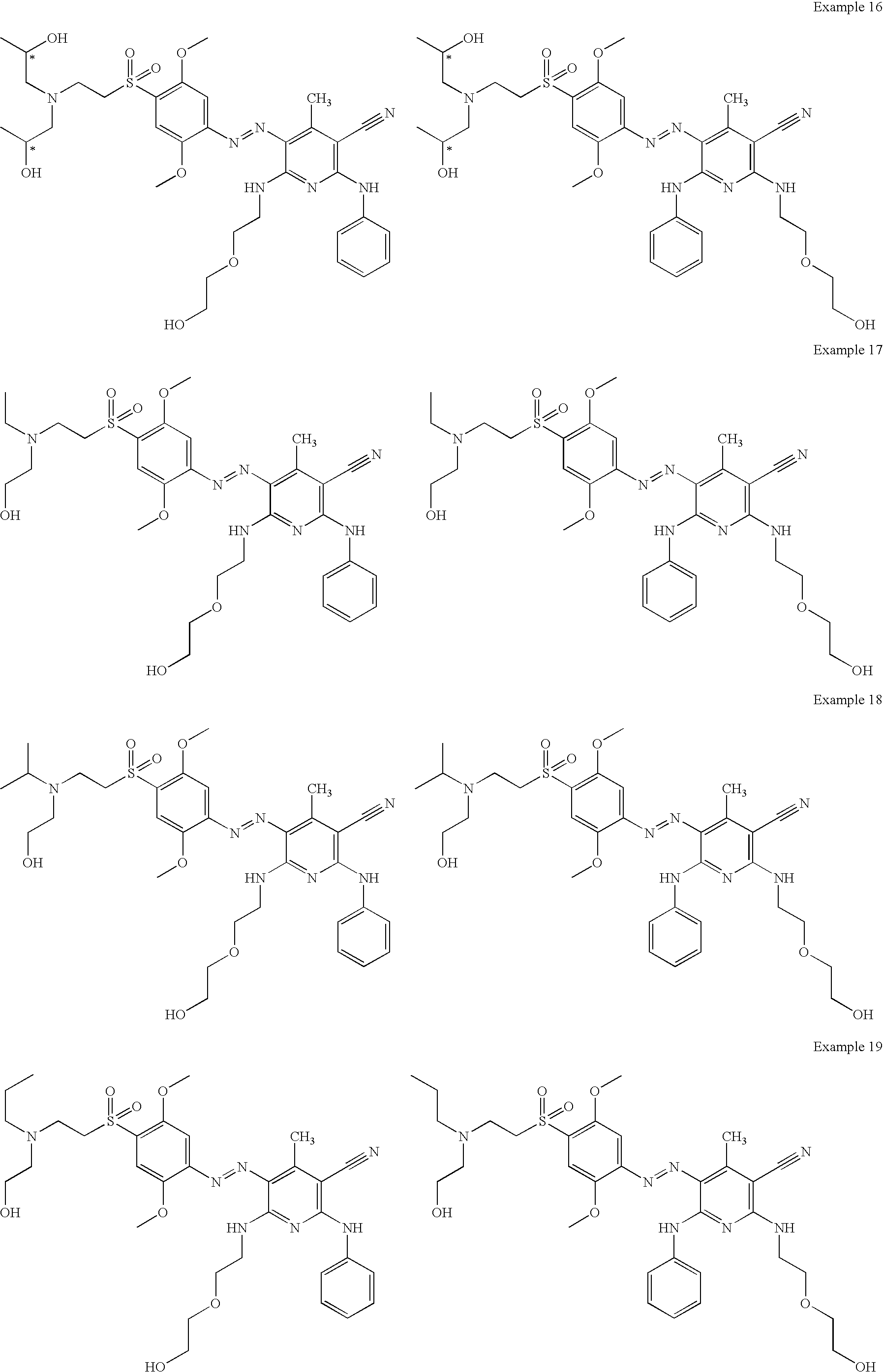

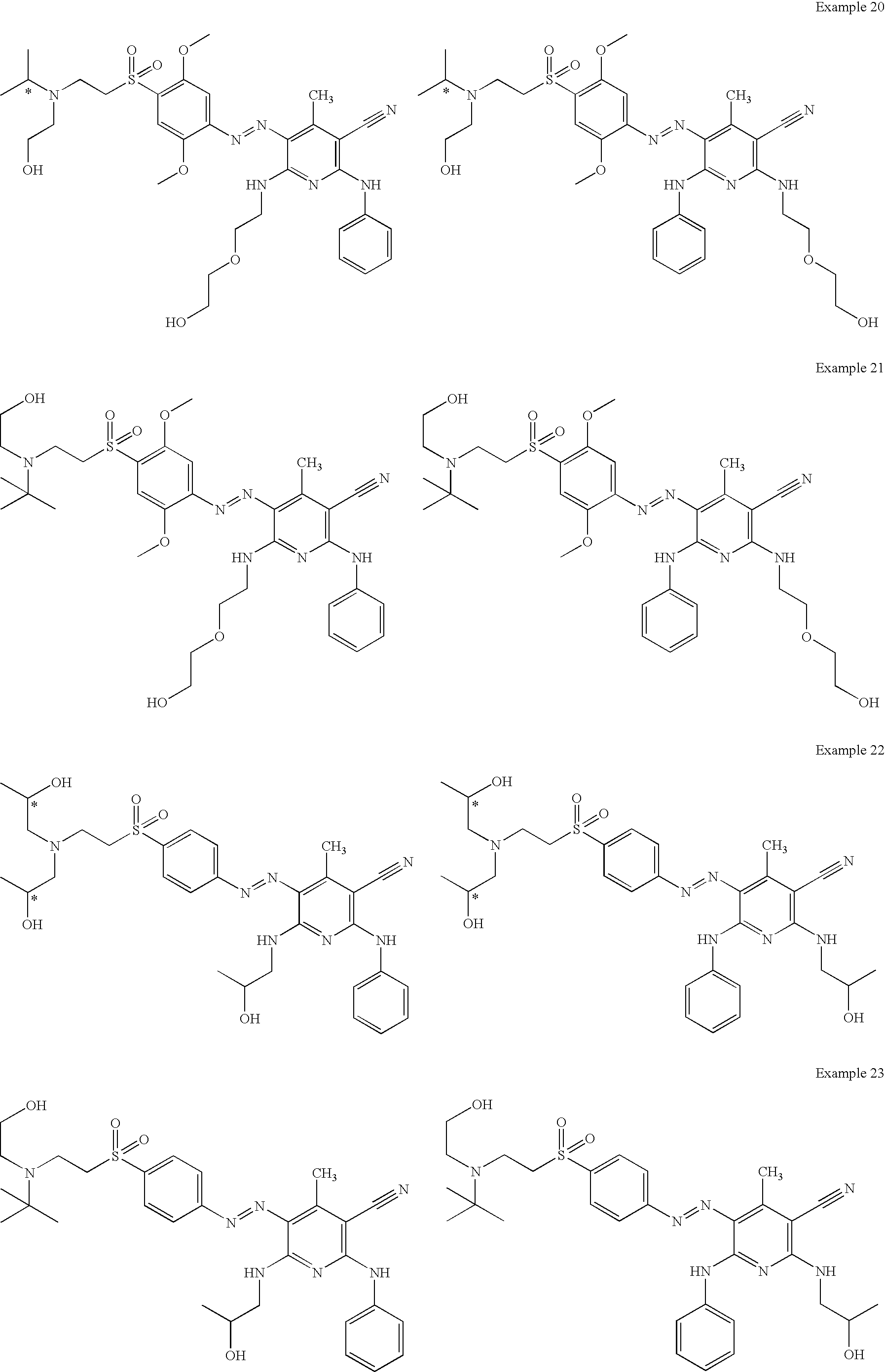

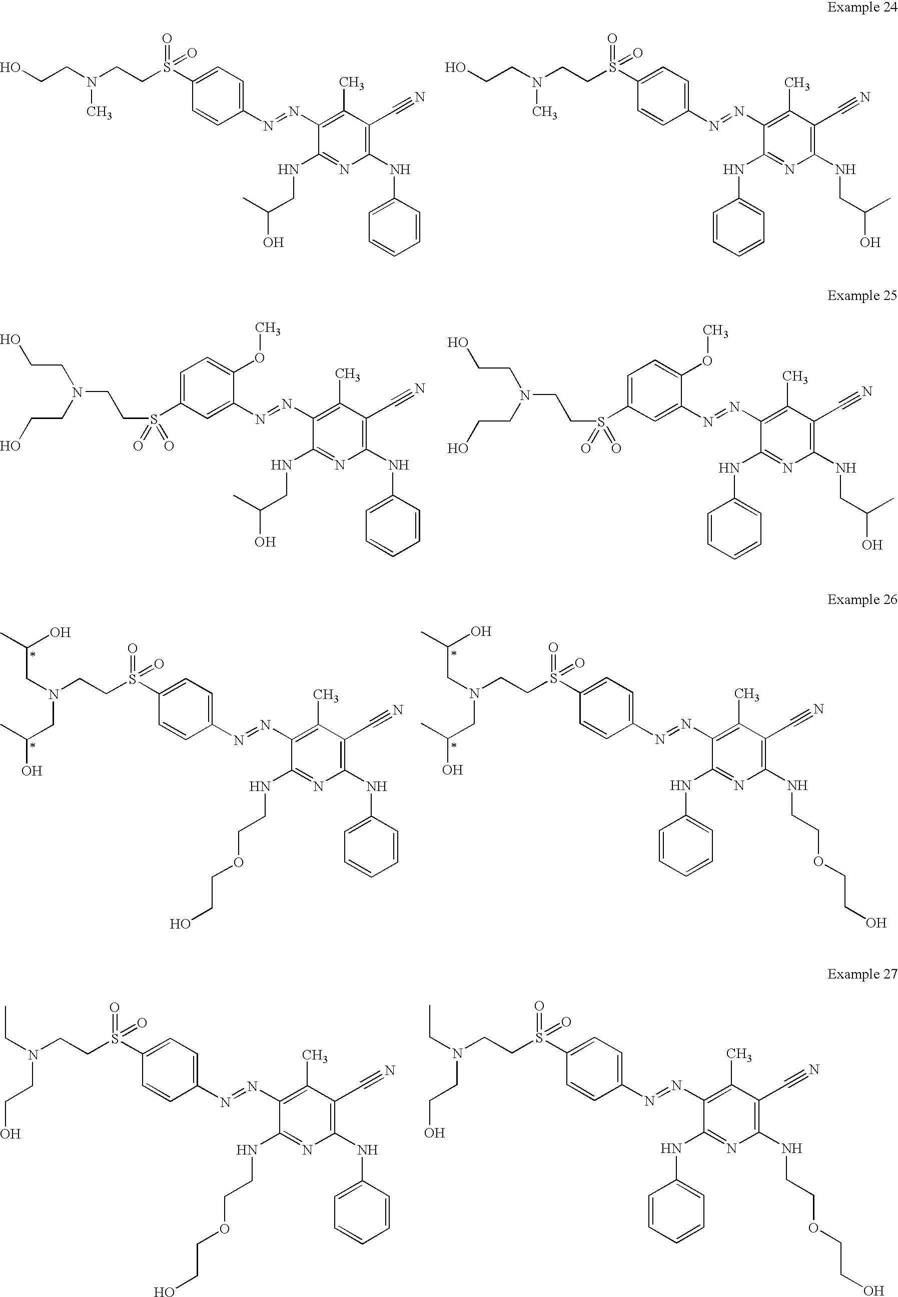

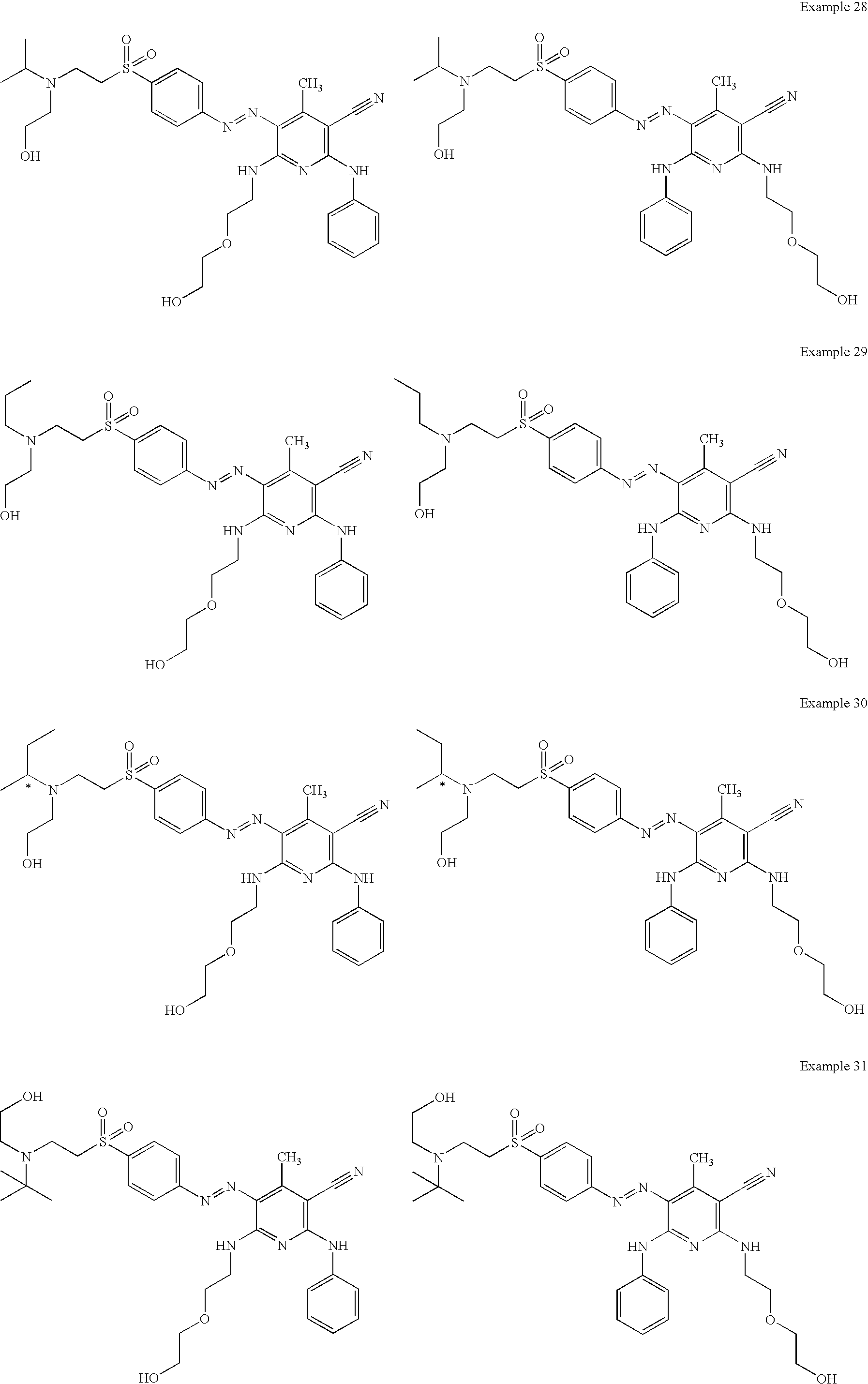

1-10. (canceled)

11. A dye of general formula (1) 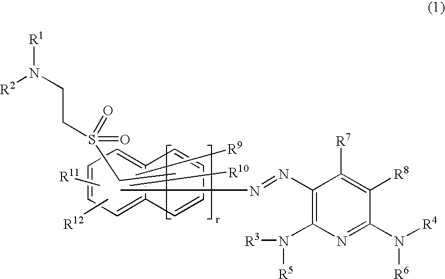
wherein
R¹ is aryl substituted by at least one hydroxyl group and optionally substituted by alkoxy, hydroxy-(C₁-C₄₀)-alkyl, (C₁-C₄₀)-alkyl, aryl, (C₂-C₄₀)-alkylene, halogen, carboxylic ester, carboxamido, or cyano; (C₁-C₆₀)-alkyl substituted by at least one hydroxyl group and optionally substituted by alkoxy, hydroxy-(C₁-C₄₀)-alkyl-, (C₁-C₄₀)-alkyl, aryl, (C₂-C₄₀)-alkylene, halogen, carboxylic ester, carboxamido, or cyano, wherein one or more C atoms are optionally replaced by oxygen, alkoxylene, arylene, carbonyl, carboxylic ester, carboxamido, sulfone, or NR¹³, wherein R¹³ is hydrogen, aryl, alkoxy, hydroxyalkyl, or alkyl, wherein one or more C atoms of said alkyl are optionally replaced by oxygen, alkoxylene, arylene, carbonyl, carboxylic ester, carboxamido, or sulfone;
R² is hydrogen; aryl; aryl substituted by hydroxyl, alkoxy, hydroxy-(C₁-C₄₀)-alkyl, (C₁-C₄₀)-alkyl, aryl, (C₂-C₄₀)-alkylene, halogen, carboxylic ester, carboxamido or cyano; (C₁-C₆₀)-alkyl; (C₁-C₆₀)-alkyl substituted by hydroxyl, alkoxy, hydroxy-(C₁-C₄₀)-alkyl, (C₁-C₄₀)-alkyl, aryl, (C₂-C₄₀)-alkylene, halogen, carboxylic ester, carboxamido, or cyano; or (C₁-C₆₀)-alkyl wherein one or more C atoms are optionally replaced by oxygen, alkoxylene, arylene, carbonyl, carboxylic ester, carboxamido, sulfone, or NR¹⁴, wherein R¹⁴ is hydrogen, aryl, alkoxy, hydroxyalkyl, or alkyl, wherein one or more C atoms of said alkyl are optionally replaced by oxygen, alkoxylene, arylene, carbonyl, carboxylic ester, carboxamido, or sulfone;
R³ and R⁴
are, independently, hydrogen; aryl; aryl substituted by hydroxyl, alkoxy, hydroxy-(C₁-C₄₀)-alkyl, (C₁-C₄₀)-alkyl, aryl, (C₂-C₄₀)-alkylene, halogen, carboxylic ester, carboxamido, or cyano; (C₁-C₆₀)-alkyl; (C₁-C₆₀)-alkyl substituted by hydroxyl, alkoxy, hydroxy-(C₁-C₄₀)-alkyl, (C₁-C₄₀)-alkyl, aryl, (C₂-C₄₀)-alkylene, halogen, carboxylic ester, carboxamido, or cyano; or (C₁-C₆₀)-alkyl wherein one or more C atoms are optionally replaced by oxygen, alkoxylene, arylene, carbonyl, carboxylic ester, carboxamido, sulfone, or NR¹⁵, wherein R¹⁵ is hydrogen, aryl, alkoxy, hydroxyalkyl, or alkyl, wherein one or more C atoms of said alkyl are optionally replaced by oxygen, alkoxylene, arylene, carbonyl, carboxylic ester, carboxamido, or sulfone;
R⁵ and R⁶
are, independently, hydrogen; aryl; aryl substituted by hydroxyl, alkoxy, hydroxy-(C₁-C₄₀)-alkyl, (C₁-C₄₀)-alkyl, aryl, (C₂-C₄₀)-alkylene, halogen, carboxylic ester, carboxamido, or cyano; (C₁-C₆₀)-alkyl; (C₁-C₆₀)-alkyl substituted by hydroxyl, alkoxy, hydroxy-(C₁-C₄₀)-alkyl, (C₁-C₄₀)-alkyl, aryl, (C₂-C₄₀)-alkylene, halogen, carboxylic ester, carboxamido or cyano; or (C₁-C₆₀)-alkyl wherein one or more C atoms are optionally replaced by oxygen, alkoxylene, arylene, carbonyl, carboxylic ester, carboxamido, sulfone, or NR¹⁶, wherein R¹⁶ is hydrogen, aryl, alkoxy, hydroxyalkyl, or alkyl, wherein one or more C atoms of said alkyl are optionally replaced by oxygen, alkoxylene, arylene, carbonyl, carboxylic ester, carboxamido, or sulfone;
R⁷ is hydrogen or (C₁-C₄)-alkyl;
R⁸ is cyano, carbamoyl, or sulfomethyl;
R⁹, R¹⁰, R¹¹, and R¹²
are, independently, hydrogen; aryl; aryl substituted by hydroxyl, alkoxy, hydroxy-(C₁-C₄₀)-alkyl, (C₁-C₄₀)-alkyl, aryl, (C₂-C₄₀)-alkylene, halogen, carboxylic ester, carboxamido, or cyano; hydroxyl, alkoxy, (C₂-C₄₀)-alkylene, halogen, carboxylic ester, carboxamido, cyano, (C₁-C₆₀)-alkyl; (C₁-C₆₀)-alkyl substituted by hydroxyl, alkoxy, hydroxy-(C₁-C₄₀)-alkyl, (C₁-C₄₀)-alkyl, aryl, (C₂-C₄₀)-alkylene, halogen, carboxylic ester, carboxamido, or cyano; or (C₁-C₆₀)-alkyl wherein one or more C atoms are optionally replaced by oxygen, alkoxylene, arylene, carbonyl, carboxylic ester, carboxamido, sulfone, or NR¹⁷, wherein R¹⁷ is hydrogen, aryl, alkoxy, hydroxyalkyl, or alkyl, wherein one or more C atoms of said alkyl are optionally replaced by oxygen, alkoxylene, arylene, carbonyl, carboxylic ester, carboxamido, or sulfone; or wherein two of R⁹, R¹⁰, R¹¹, and R¹² combine with the carbon atoms to which they are attached to define a ring optionally substituted by hydroxyl, alkoxy, hydroxy-(C₁-C₄₀)-alkyl, (C₁-C₄₀)-alkyl, aryl, (C₂-C₄₀)-alkylene, halogen, carboxylic ester, carboxamido, or cyano;
r is 0 or 1, and
one or more of R², R³, R⁴, R⁵, R⁶, R⁷, R⁸, R⁹, R¹⁰, R¹¹, R¹², R¹³, R¹⁴, R¹⁵, R¹⁶ and R¹⁷ each contain at least one hydroxyl group.

12. The dye of claim 11, wherein
R¹ is hydroxy-(C₁-C₄)-alkyl or hydroxy-(C₁-C₄)-alkoxy-(C₁-C₄)-alkyl;
R² is hydrogen, (C₁-C₄)-alkyl, hydroxy-(C₁-C₄)-alkyl or hydroxy-(C₁-C₄)-alkoxy-(C₁-C₄)-alkyl;
R³ and R⁴
are each hydrogen;
R⁵ and RF
are, independently, hydrogen; (C₁-C₄)-alkyl; hydroxy-(C₁-C₄)-alkyl; hydroxy-(C₁-C₄)-alkoxy-(C₁-C₄)-alkyl; (C₁-C₄)-alkoxy-(C₁-C₄)-alkyl; phenyl; or phenyl substituted by (C₁-C₄)-alkyl or (C₁-C₄)-alkoxy;
R⁷ is (C₁-C₄)-alkyl;
R⁸ is cyano; and
R⁹ and R¹²
are, independently, hydrogen, (C₁-C₄)-alkyl or (C₁-C₄)-alkoxy; and r is 0 or 1.

13. The dye of claim 11, having the general formula (1a)

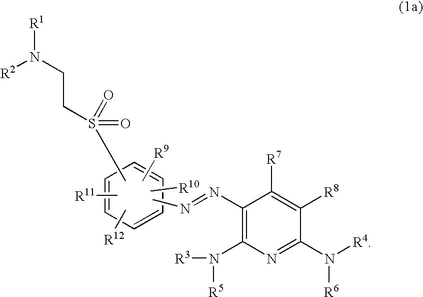

14. The dye of claim 11, having the general formula (1c) 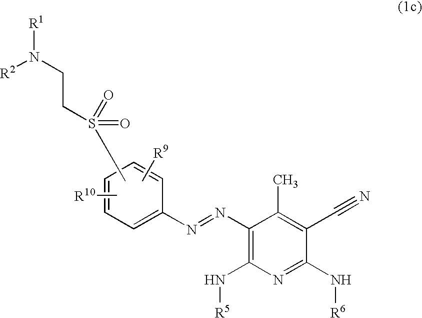
wherein
R¹ is hydroxyethyl, hydroxypropyl, or hydroxyethoxyethyl;
R² is methyl, ethyl, hydroxyethyl, hydroxypropyl, or hydroxyethoxyethyl;
R⁵ and R⁶
are, independently, hydrogen, (C₁-C₄)-alkyl, hydroxyethyl, hydroxypropyl, hydroxy-(C₁-C₄)-alkoxyethyl, ethoxy-(C₁-C₄)-alkyl, methoxy-(C₁-C₄)-alkyl, phenyl, methylphenyl, or methoxyphenyl; and
R⁹ and R¹⁰
are, independently, hydrogen, methyl, or methoxy.

15. A process for preparing the dye of claim 11, comprising diazotizing a compound of general formula (D1) 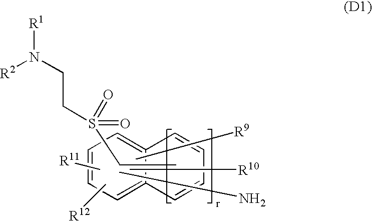
wherein
R¹ is aryl substituted by at least one hydroxyl group and optionally substituted by alkoxy, hydroxy-(C₁-C₄₀)-alkyl, (C₁-C₄₀)-alkyl, aryl, (C₂-C₄₀)-alkylene, halogen, carboxylic ester, carboxamido, or cyano; (C₁-C₆₀)-alkyl substituted by at least one hydroxyl group and optionally substituted by alkoxy, hydroxy-(C₁-C₄₀)-alkyl-, (C₁-C₄₀)-alkyl, aryl, (C₂-C₄₀)-alkylene, halogen, carboxylic ester, carboxamido, or cyano, wherein one or more C atoms are optionally replaced by oxygen, alkoxylene, arylene, carbonyl, carboxylic ester, carboxamido, sulfone, or NR³, wherein R¹³ is hydrogen, aryl, alkoxy, hydroxyalkyl, or alkyl, wherein one or more C atoms of said alkyl are optionally replaced by oxygen, alkoxylene, arylene, carbonyl, carboxylic ester, carboxamido, or sulfone;
R² is hydrogen; aryl; aryl substituted by hydroxyl, alkoxy, hydroxy-(C₁-C₄₀)-alkyl, (C₁-C₄₀)-alkyl, aryl, (C₂-C₄₀)-alkylene, halogen, carboxylic ester, carboxamido or cyano; (C₁-C₆₀)-alkyl; (C₁-C₆₀)-alkyl substituted by hydroxyl, alkoxy, hydroxy-(C₁-C₄₀)-alkyl, (C₁-C₄₀)-alkyl, aryl, (C₂-C₄₀)-alkylene, halogen, carboxylic ester, carboxamido, or cyano; or (C₁-C₆₀)-alkyl wherein one or more C atoms are optionally replaced by oxygen, alkoxylene, arylene, carbonyl, carboxylic ester, carboxamido, sulfone, or NR¹⁴, wherein R¹⁴ is hydrogen, aryl, alkoxy, hydroxyalkyl, or alkyl, wherein one or more C atoms of said alkyl are optionally replaced by oxygen, alkoxylene, arylene, carbonyl, carboxylic ester, carboxamido, or sulfone; and
R⁹, R¹⁰, R¹¹, and R¹²
are, independently, hydrogen; aryl; aryl substituted by hydroxyl, alkoxy, hydroxy-(C₁-C₄₀)-alkyl, (C₁-C₄₀)-alkyl, aryl, (C₂-C₄₀)-alkylene, halogen, carboxylic ester, carboxamido, or cyano; hydroxyl, alkoxy, (C₂-C₄₀)-alkylene, halogen, carboxylic ester, carboxamido, cyano, (C₁-C₆₀)-alkyl; (C₁-C₆₀)-alkyl substituted by hydroxyl, alkoxy, hydroxy-(C₁-C₄₀)-alkyl, (C₁-C₄₀)-alkyl, aryl, (C₂-C₄₀)-alkylene, halogen, carboxylic ester, carboxamido, or cyano; or (C₁-C₆₀)-alkyl wherein one or more C atoms are optionally replaced by oxygen, alkoxylene, arylene, carbonyl, carboxylic ester, carboxamido, sulfone, or NR¹⁷, wherein R¹⁷ is hydrogen, aryl, alkoxy, hydroxyalkyl, or alkyl, wherein one or more C atoms of said alkyl are optionally replaced by oxygen, alkoxylene, arylene, carbonyl, carboxylic ester, carboxamido, or sulfone; or wherein two of R⁹, R¹⁰, R¹¹, and R¹² combine with the carbon atoms to which they are attached to define a ring optionally substituted by hydroxyl, alkoxy, hydroxy-(C₁-C₄₀)-alkyl, (C₁-C₄₀)-alkyl, aryl, (C₂-C₄₀)-alkylene, halogen, carboxylic ester, carboxamido, or cyano;
and coupling said compound of general formula (D1) onto a compound of general formula (K1) 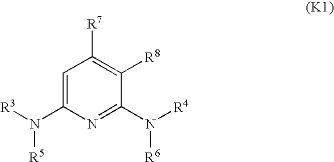
wherein
R³ and R⁴
are, independently, hydrogen; aryl; aryl substituted by hydroxyl, alkoxy, hydroxy-(C₁-C₄₀)-alkyl, (C₁-C₄₀)-alkyl, aryl, (C₂-C₄₀)-alkylene, halogen, carboxylic ester, carboxamido, or cyano; (C₁-C₆₀)-alkyl; (C₁-C₆₀)-alkyl substituted by hydroxyl, alkoxy, hydroxy-(C₁-C₄₀)-alkyl, (C₁-C₄₀)-alkyl, aryl, (C₂-C₄₀)-alkylene, halogen, carboxylic ester, carboxamido, or cyano; or (C₁-C₆₀)-alkyl wherein one or more C atoms are optionally replaced by oxygen, alkoxylene, arylene, carbonyl, carboxylic ester, carboxamido, sulfone, or NR¹⁵, wherein R¹⁵ is hydrogen, aryl, alkoxy, hydroxyalkyl, or alkyl, wherein one or more C atoms of said alkyl are optionally replaced by oxygen, alkoxylene, arylene, carbonyl, carboxylic ester, carboxamido, or sulfone;
R⁵ and R⁶
are, independently, hydrogen; aryl; aryl substituted by hydroxyl, alkoxy, hydroxy-(C₁-C₄₀)-alkyl, (C₁-C₄₀)-alkyl, aryl, (C₂-C₄₀)-alkylene, halogen, carboxylic ester, carboxamido, or cyano; (C₁-C₆₀)-alkyl; (C₁-C₆₀)-alkyl substituted by hydroxyl, alkoxy, hydroxy-(C₁-C₄₀)-alkyl, (C₁-C₄₀)-alkyl, aryl, (C₂-C₄₀)-alkylene, halogen, carboxylic ester, carboxamido or cyano; or (C₁-C₆₀)-alkyl wherein one or more C atoms are optionally replaced by oxygen, alkoxylene, arylene, carbonyl, carboxylic ester, carboxamido, sulfone, or NR¹⁶, wherein R¹⁶ is hydrogen, aryl, alkoxy, hydroxyalkyl, or alkyl, wherein one or more C atoms of said alkyl are optionally replaced by oxygen, alkoxylene, arylene, carbonyl, carboxylic ester, carboxamido, or sulfone;
R⁷ is hydrogen or (C₁-C₄)-alkyl; and
R⁸ is cyano, carbamoyl, or sulfomethyl.

16. A process for preparing the dye of claim 11, comprising reacting a compound of general formula (ZP1) 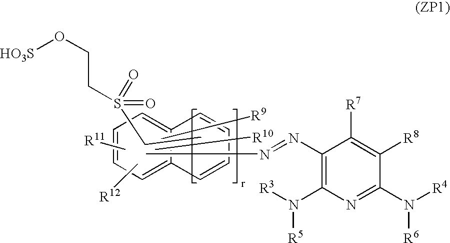
wherein
R³ and R⁴
are, independently, hydrogen; aryl; aryl substituted by hydroxyl, alkoxy, hydroxy-(C₁-C₄₀)-alkyl, (C₁-C₄₀)-alkyl, aryl, (C₂-C₄₀)-alkylene, halogen, carboxylic ester, carboxamido, or cyano; (C₁-C₆₀)-alkyl; (C₁-C₆₀)-alkyl substituted by hydroxyl, alkoxy, hydroxy-(C₁-C₄₀)-alkyl, (C₁-C₄₀)-alkyl, aryl, (C₁-C₄₀)-alkylene, halogen, carboxylic ester, carboxamido, or cyano; or (C₁-C₆₀)-alkyl wherein one or more C atoms are optionally replaced by oxygen, alkoxylene, arylene, carbonyl, carboxylic ester, carboxamido, sulfone, or NR¹⁵, wherein R¹⁵ is hydrogen, aryl, alkoxy, hydroxyalkyl, or alkyl, wherein one or more C atoms of said alkyl are optionally replaced by oxygen, alkoxylene, arylene, carbonyl, carboxylic ester, carboxamido, or sulfone;
R⁵ and R⁶
are, independently, hydrogen; aryl; aryl substituted by hydroxyl, alkoxy, hydroxy-(C₁-C₄₀)-alkyl, (C₁-C₄₀)-alkyl, aryl, (C₂-C₄₀)-alkylene, halogen, carboxylic ester, carboxamido, or cyano; (C₁-C₆₀)-alkyl; (C₁-C₆₀)-alkyl substituted by hydroxyl, alkoxy, hydroxy-(C₁-C₄₀)-alkyl, (C₁-C₄₀)-alkyl, aryl, (C₂-C₄₀)-alkylene, halogen, carboxylic ester, carboxamido or cyano; or (C₁-C₆₀)-allyl wherein one or more C atoms are optionally replaced by oxygen, alkoxylene, arylene, carbonyl, carboxylic ester, carboxamido, sulfone, or NR¹⁶, wherein R¹⁶ is hydrogen, aryl, alkoxy, hydroxyalkyl, or alkyl, wherein one or more C atoms of said alkyl are optionally replaced by oxygen, alkoxylene, arylene, carbonyl, carboxylic ester, carboxamido, or sulfone;
R⁷ is hydrogen or (C₁-C₄)-alkyl;
R⁸ is cyano, carbamoyl, or sulfomethyl;
R⁹, R¹⁰, R¹¹, and R¹²
are, independently, hydrogen; aryl; aryl substituted by hydroxyl, alkoxy, hydroxy-(C₁-C₄₀)-alkyl, (C₁-C₄₀)-alkyl, aryl, (C₂-C₄₀)-alkylene, halogen, carboxylic ester, carboxamido, or cyano; hydroxyl, alkoxy, (C₂-C₄₀)-alkylene, halogen, carboxylic ester, carboxamido, cyano, (C₁-C₆₀)-alkyl; (C₁-C₆₀)-alkyl substituted by hydroxyl, alkoxy, hydroxy-(C₁-C₄₀)-alkyl, (C₁-C₄₀)-alkyl, aryl, (C₂-C₄₀)-alkylene, halogen, carboxylic ester, carboxamido, or cyano; or (C₁-C₆₀)-alkyl wherein one or more C atoms are optionally replaced by oxygen, alkoxylene, arylene, carbonyl, carboxylic ester, carboxamido, sulfone, or NR¹⁷, wherein R¹⁷ is hydrogen, aryl, alkoxy, hydroxyalkyl, or alkyl, wherein one or more C atoms of said alkyl are optionally replaced by oxygen, alkoxylene, arylene, carbonyl, carboxylic ester, carboxamido, or sulfone; or wherein two of R⁹, R¹⁰, R¹¹, and R¹² combine with the carbon atoms to which they are attached to define a ring optionally substituted by hydroxyl, alkoxy, hydroxy-(C₁-C₄₀)-alkyl, (C₁-C₄₀)-alkyl, aryl, (C₂-C₄₀)-alkylene, halogen, carboxylic ester, carboxamido, or cyano; and
r is 0 or 1;
with an amine of formula HNR¹R², wherein
R¹ is aryl substituted by at least one hydroxyl group and optionally substituted by alkoxy, hydroxy-(C₁-C₄₀)-alkyl, (C₁-C₄₀)-alkyl, aryl, (C₂-C₄₀)-alkylene, halogen, carboxylic ester, carboxamido, or cyano; (C₁-C₆₀)-alkyl substituted by at least one hydroxyl group and optionally substituted by alkoxy, hydroxy-(C₁-C₄₀)-alkyl-, (C₁-C₄₀)-alkyl, aryl, (C₂-C₄₀)-alkylene, halogen, carboxylic ester, carboxamido, or cyano, wherein one or more C atoms are optionally replaced by oxygen, alkoxylene, arylene, carbonyl, carboxylic ester, carboxamido, sulfone, or NR¹³, wherein R¹³ is hydrogen, aryl, alkoxy, hydroxyalkyl, or alkyl, wherein one or more C atoms of said alkyl are optionally replaced by oxygen, alkoxylene, arylene, carbonyl, carboxylic ester, carboxamido, or sulfone; and
R² is hydrogen; aryl; aryl substituted by hydroxyl, alkoxy, hydroxy-(C₁-C₄₀)-alkyl, (C₁-C₄₀)-alkyl, aryl, (C₂-C₄₀)-alkylene, halogen, carboxylic ester, carboxamido or cyano; (C₁-C₆₀)-alkyl; (C₁-C₆₀)-alkyl substituted by hydroxyl, alkoxy, hydroxy-(C₁-C₄₀)-alkyl, (C₁-C₄₀)-alkyl, aryl, (C₂-C₄₀)-allylene, halogen, carboxylic ester, carboxamido, or cyano; or (C₁-C₆₀)-alkyl wherein one or more C atoms are optionally replaced by oxygen, alkoxylene, arylene, carbonyl, carboxylic ester, carboxamido, sulfone, or NR¹⁴, wherein R¹⁴ is hydrogen, aryl, alkoxy, hydroxyalkyl, or alkyl, wherein one or more C atoms of said alkyl are optionally replaced by oxygen, alkoxylene, arylene, carbonyl, carboxylic ester, carboxamido, or sulfone.

17. A dye mixture comprising two or more dyes of claim 11.

18. A polymer comprising the dye of claim 11.

19. The polymer of claim 18, wherein said polymer is polyurethane.

20. The polymer of claim 18, wherein said polymer is polyurethane foam.

21. A polymer comprising the dye mixture of claim 17.

22. The polymer of claim 21, wherein said polymer is polyurethane.

23. The polymer of claim 21, wherein said polymer is polyurethane foam.
